(19) United States
(12) Patent Application Publication
(10) Pub. No.: US 2008/0011876 A1
(43) Pub. Date: Jan. 17, 2008

(54) PARTICLE GENERATOR

(76) Inventor: MICHELE L. OSTRAAT, Jamison, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/775,378

(22) Filed: Jul. 10, 2007

Related U.S. Application Data
(60) Provisional application No. 60/830,149, filed on Jul. 10, 2006.

(51) Int. Cl. B05B 1/24; F22B 1/00

(52) U.S. Cl. 239/136; 122/4 R; 222/3; 239/8

(57) ABSTRACT

Disclosed is a method and apparatus to produce an aerosol of particles, particularly nanoparticles.

This application claims the benefit of U.S. Provisional Application No. 60/830,149, filed Jul. 10, 2006, which is incorporated in its entirety as a part hereof for all purposes.

### TECHNICAL FIELD

This application relates to a method and apparatus for the production of particles, particularly particles having a median diameter in the range of about 1 to about 100 nanometers (nm). The method and apparatus of this invention are capable of producing a sample of particles having a controlled concentration and size distribution. This is useful in relation to the need to be able to subject such a sample to various manipulations, and to then further analyze the sample to determine how its characteristics, including concentration and size distribution, have been affected by the manipulations.

### BACKGROUND

The commercial-scale deployment of nanotechnology has raised many safety, health and environmental questions that must be addressed, including the potential inhalation exposure of nanoparticles and potential risks associated with this exposure.

Engineered nanoparticles, as currently defined by the National Nanotechnology Initiative, have at least one dimension in the range of 1 to 100 nanometers, and they possess unique properties and functions because of their nanometer-scale dimensions. Engineered nanoparticles are becoming incorporated into an increasing number of products across a wide variety of applications, and the opportunities and mechanisms for exposure are thus just as varied, and can include inhalation, ingestion, ocular and transdermal exposure.

Prudent practices for nanotechnology safety, health, and environmental care recognize the importance of particle containment, and measures for exposure control. Measures to contain, and control potential exposures to, airborne nanoparticles should include good handling techniques and work practices, a wide variety of engineering controls (e.g. isolating the hazard at the source, and providing appropriate ventilation and exhaust systems), and providing suitable personal protective equipment, such as protective clothing, gloves, and respiratory protection. Measuring the collection efficiency of particulate filters and filter media to engineered nanoparticles is an important aspect of all these efforts. Having an understanding of the collection efficiency of a filter will compliment the decision to institute controls (e.g. respiratory protection) based on the results of risk assessment and risk management.

Current protocols and equipment to assess the effectiveness of workplace controls, and to monitor workplace conditions for the protection of employees from exposure to aerosolized particles, are addressed primarily to particles in the greater than 100 nm size range. The effectiveness of these current containment and control measures must either be verified for particles in the less than 100 nm size range, or new methods for reducing inhalation exposure risk to nanoparticles must be developed.

A need thus exists for more extensive analysis of the properties and behavior of particles, and particularly nanoparticles. Although multiple avenues are available to synthesize nanoparticles, few tools are accessible to industrial hygienists and inhalation toxicologists to produce well-characterized aerosols of particles of known particle-size distribution and particle number concentration that are stable, simple and robust to operate.

Aerosol particles have previously been synthesized in industrial quantities as aerosols from materials such as TiO₂, carbon black and SiO₂. Various methods exist to synthesize these aerosols, including spray pyrolysis, flame synthesis, thermal evaporation, and spray drying of colloidal or precipitated particles. Particularly in industrial-scale reactors, the resulting aerosol is typically comprised of highly agglomerated nanometer-sized primary particles such that the particles in the final aerosol can be several hundred nanometers in mobility diameter. SiO₂ aerosol particle formation mechanisms such as the sintering of SiO₂ via viscous flow, and agglomerated particle formation by coagulation and sintering in high temperature gas phase synthesis of SiO₂, have been modeled and characterized. Other authors have examined the effects of SiO₂ particle size on coalescence rate, and have developed models to account for the effects of process parameters (including temperature, residence time, precursor concentration and cooling rate) on the degree of agglomeration of SiO₂ formed by methods such as simultaneous chemical reactions, coagulation, and sintering.

The ability to perform the needed analysis on nanoparticles and other kinds of particles will thus be decidedly enhanced by the availability of a method and apparatus that are capable of producing a sample of particles having a controlled concentration and size distribution.

### SUMMARY

In one embodiment, this invention provides a method of producing aerosol particles from a precursor material by (a) providing a vapor of the precursor material, and (b) thermally decomposing the vapor.

In another embodiment, this invention provides an apparatus for producing aerosol particles from a precursor material that includes (a) an evaporator to form a vapor of the precursor material, and (b) means to thermally decompose the vapor.

It has been found that the methods and apparatus provided by this invention are useful for the production of aerosol particles, particularly aerosol nanoparticles. Among other benefits, the ability to produce a population of such particles having a controlled concentration and size distribution enables the evaluation of characteristics of aerosol particles in a manner that will assist with the determination of whether (i) new or different health or environmental concerns are observed between a material with nanoscale dimensions versus the same material with greater than nanoscale dimensions, (ii) traditional air cleaning systems currently used to clean and recirculate ambient workplace air operate correctly in the presence of nanoparticles, (iii) existing engineering controls designed to control dust or emissions function properly when nanoparticles are present, (iv) personal protective equipment provides an effective barrier to nanoparticles, and (v) the presence of nanoparticles changes the fire or explosion hazard of a process.

### BRIEF DESCRIPTION OF THE DRAWING

FIG. 1 shows a schematic layout of a laboratory-scale particle generator, together with a classification and detection system, to produce aerosol particles having a controlled median diameter and number concentration.

### DETAILED DESCRIPTION

Due to the behavior of aerosol nanoparticles and their instability as a function of time, aerosol nanoparticles currently cannot be collected and stored for future use while simultaneously preserving the original aerosol size distribution or properties. For this reason, equipment involved in studies involving aerosol nanoparticles and their properties must maintain an aerosol nanoparticle generator in situ within a process, and upstream of characterization equipment such as filter testing units or inhalation toxicology equipment. This equipment must be easy to use and operate, and must demonstrate the ability to provide long-term, stable, reproducible production of aerosol nanoparticles. An aerosol of solid nanoparticles with a specific particle size, size distribution and number concentration cannot be recreated simply by re-aerosolizing that same solid material once it has been collected in bulk.

One embodiment of an apparatus as provided by this invention produces aerosol particles from a precursor material. Aerosol particles are particles contained in an aerosol, which is a gaseous suspension of extremely small particles of a liquid or solid. The aerosol particles produced by the apparatus hereof may have a median particle diameter (“d₅₀”) in the range of less than about 100 nm, and more particularly in the range of about 10 to about 100 nm or about 10 to about 70 nm, and may have a particle concentration of less than about 10⁷ particles/cm³, for example about 10⁴ to about 10⁷ particles/cm³

The median diameter of a population of particles is the diameter at which half of the population has a larger diameter, and half has a smaller diameter, and is thus the 50% size of a cumulative distribution curve of the particle sizes. The diameter used herein to characterize nanoparticles is the mobility diameter (“dₘ”), an equivalent sphere diameter, which is the diameter of a regular, homogeneous sphere having the same properties as the particle in question. The mobility diameter of a particle is related to the terminal velocity of the particle, the velocity when the electrical and drag forces are balanced when the particle is being accelerated in an electric field. The mobility diameter can be expressed in terms of the volume equivalent diameter (the diameter of a sphere having the same volume as the particle) and a shape factor that accounts for the effect of the non-spherical shape of the particle on the drag force, as corrected for the reduced drag on particles having a diameter on the order of or smaller than the gas mean free path. Another representative description of mobility diameter may also be found, for example, in De Carlo et al, “Particle Morphology and Density Characterization by Combined Mobility and Aerodynamic Diameter Measurements. Part I: Theory”, in Aerosol Science Technology, 38(12), 1185-1205 (2004). The mobility diameter of a particle, or population thereof, is typically ascertained with a differential mobility analyzer, as described below.

A suitable precursor material from which to prepare nanoparticles includes essentially any substance that can be volatilized, including materials that contain carbon, silicon or titanium, such as carbon black or titanium isopropoxide (from which titanium dioxide particles may be prepared). Tetraethylorthosilicate (“TEOS”), for example, can be used as a precursor material from which SiO₂ particles can be produced as TEOS vapor can undergo homogeneous nucleation at sufficient rates to produce solid SiO₂ aerosol nanoparticles at reaction temperatures at or above 800° C.

One embodiment of the apparatus hereof includes (a) an evaporator to form a vapor of the precursor material, and (b) means to thermally decompose the vapor. The evaporator places the precursor material at a temperature at which the precursor material is formed into a gas by being volatilized, and a vapor thereof is thus formed. The vapor of the precursor material is then thermally decomposed by feeding it from the evaporator to means for thermally decomposing the vapor, which raises the vapor to a temperature at which the precursor material decomposes. Means for thermally decomposing the vapor may include, for example, a furnace, an oven, an open flame or a laser into which the vapor is fed.

In the vapor of the precursor material as formed by the evaporator, and as later thermally decomposed, all or substantially all of the vapor exists in the form of a gas. Substantially all of the vapor exists in the form of a gas when at least 80 wt %, or alternatively at least 90 wt %, or alternatively at least 95 wt %, or alternatively at least 99 wt % of the vapor exists in the form of a gas.

In alternative embodiments of this apparatus, the evaporator may be an enclosed container, and may be temperature controlled. The evaporator may be temperature controlled by the use of a heating or cooling jacket, and it thus may either heat or cool the precursor material. In general, the evaporator is heated when the precursor material volatilizes only above the ambient temperature; and the evaporator is cooled when the precursor material volatilizes at ambient temperature or below, and there is a need to cool the material to control the rate of volatilization, for example by reducing the rate of volatilization.

In other embodiments of this apparatus, the evaporator may further include a mixing device to form a mixture of the vapor and a carrier gas. A suitable carrier gas may include an inert gas such as nitrogen or argon, or a reactive gas such as oxygen. The carrier gas to be used is preferably dried to avoid contamination of the precursor material, or the vapor thereof, with moisture in any manner in which the presence of moisture in the vapor of the precursor material would cause a change in the vapor pressure of the precursor material in the evaporator. Such change in vapor pressure could result in a decrease of the particle size and concentration of the aerosol particles produced from the vapor. A mixing device to form a mixture of a carrier gas and the vapor of the precursor material may include an inflow tube through which carrier gas is fed into the evaporator. Upon entering the evaporator, the carrier gas mixes with the vapor of the precursor material and forms a mixture. When a mixture of vapor and carrier gas is formed, the mixture is fed to the means for thermally decomposing the vapor wherein the vapor in gaseous form is thermally decomposed in the presence of the carrier gas.

In embodiments of the apparatus hereof where the evaporator is an enclosed container, liquid precursor material may be heated or cooled to provide a vapor thereof in a space of the container that is positioned above the surface of the liquid (the “vapor space”). The apparatus may then include an inflow tube through which carrier gas is fed into the container, and an outflow tube to discharge a mixture of vapor and carrier gas. In one embodiment, carrier gas may be fed into the vapor space, i.e. above the surface of the liquid being volatilized, and in an alternative embodiment, carrier gas may be fed into the liquid beneath the surface thereof.

In other embodiments, the apparatus may include a diluent tube through which diluent carrier gas, i.e. carrier gas neat that is unmixed with any vapor of the precursor material, is fed into the previously-formed mixture of vapor and carrier gas. The apparatus may, in such embodiments, further include a valve to regulate the flow of carrier gas in the inflow tube, and a valve to regulate the flow of diluent carrier gas in the diluent tube. These valves may be controlled, to regulate the individual flows of carrier gas, separately or together.

The particle generator provided as an embodiment of the apparatus of this invention is capable of synthesizing a stable source of aerosol nanoparticles with no undesired byproducts. Due to the long-term stability and the reproducibility of the aerosol nanoparticle size distributions provided by this generator, constant monitoring of this generator is typically not necessary.

An apparatus as provided by this invention may be operated by a method of this invention. Such a method produces aerosol particles from a precursor material by (a) providing a vapor of the precursor material, and (b) thermally decomposing that vapor. The aerosol particles produced by the method hereof may have a median particle diameter in the range of less than about 100 nm, and more particularly in the range of about 10 to about 100 nm or about 10 to about 70 nm, and may have a particle concentration of less than about 10⁷ particles/cm³, for example about 10⁴ to about 10⁷ particles/cm³

In the method hereof, a vapor of the precursor material may be provided by volatilizing a precursor material in an evaporator, as described above, to form a vapor, and the vapor may be thermally decomposed by passing it to means for thermal decomposition, such as a furnace or other similar device as described above. The method may further include a step of regulating the temperature at which thermal decomposition of the vapor occurs.

In the vapor of the precursor material as initially formed, and as later thermally decomposed, all or substantially all of the vapor exists in the form of a gas. Substantially all of the vapor exists in the form of a gas when at least 80 wt %, or alternatively at least 90 wt %, or alternatively at least 95 wt %, or alternatively at least 99 wt % of the vapor exists in the form of a gas.

One embodiment of the method hereof includes a step of contacting the vapor with a carrier gas to form a mixture thereof. As described above, a suitable carrier gas may include an inert gas such nitrogen or argon, or a reactive gas such as oxygen. When a mixture of vapor and carrier gas is formed (an “initial mixture”), such mixture is fed to means for thermally decomposing the vapor (such as a furnace) wherein the vapor is thermally decomposed in the presence of the carrier gas.

In embodiments where a carrier gas is provided, the method may further involve regulating the rate of flow of carrier gas. An initial mixture formed by blending carrier gas with precursor material vapor may in turn be contacted with additional, diluent carrier gas, which is carrier gas neat that is unmixed with any precursor material vapor, to form a diluted mixture of the vapor and carrier gas. The rate of flow of the carrier gas forming the initial mixture of vapor and carrier gas, and the rate of flow of the diluent carrier gas, may be regulated separately or together.

In yet another embodiment of this method, the precursor material may be vaporized from a liquid, and for such purpose, the method may include providing an enclosed container in which liquid precursor material is temperature controlled to provide volatilized precursor material in a space of the container above the surface of the liquid (the “vapor space”). In such embodiment, a carrier gas may be fed into the vapor space above the surface of the liquid, or may be fed into the liquid beneath its surface. The liquid may be temperature controlled by heating or cooling it.

In the method hereof, the vapor of the precursor material, together with the carrier gas that has been admixed therewith, is fed to means for thermal decomposition such as a furnace. The vapor of the precursor material is then decomposed in the presence of the carrier gas, and the product of that decomposition then nucleates or coalesces to form solid particles in an aerosol, which results in completion of the method hereof to produce aerosol particles.

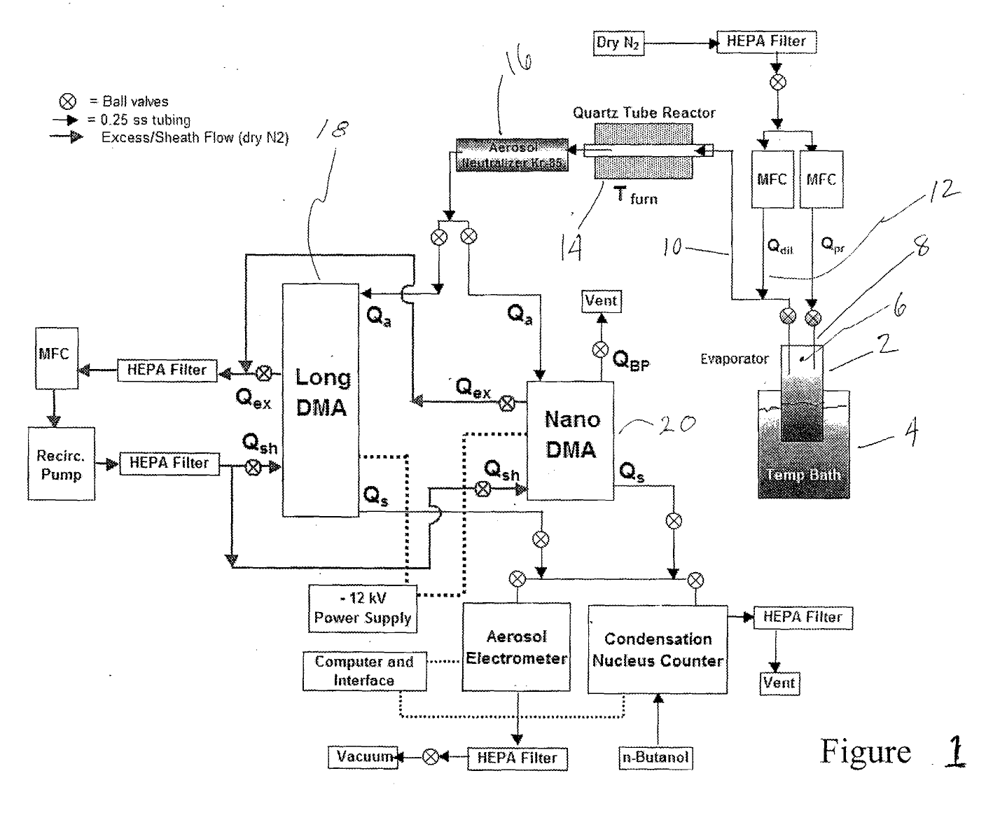

Shown in FIG. 1 is a schematic representation of a laboratory-scale embodiment of the apparatus hereof, which may be used as a particle generator to provide aerosol particles for experimental work. Liquid precursor material is contained within an evaporator 2 that is placed into a controlled temperature bath 4. The evaporator may, for example, be an enclosed container manufactured from a closed glass weld (MDC part #463002), and may suitably be provided with a total liquid surface area of about 7.9 cm². The liquid level of liquid precursor may suitably be maintained such that the gas volume in the evaporator is about 55 cm³. The evaporator 2 produces a vapor of the precursor material, and the vapor resides in a vapor space 6 of the evaporator that is above the level of the liquid that is within the evaporator 2.

A dual tube fluid feedthrough (MDC part #610002) provides an inflow tube 8, an outflow tube 10, and diluent tube 12. A carrier gas is fed into the evaporator 2 through inflow tube 8, and therein forms a mixture with the vapor of the precursor material in vapor space 6. In this particular embodiment, for example, a flow of dry, particle-free N₂ gas is divided into two flows, namely Qₚᵣ, which flows through the inflow tube 8, and Q_{dil}, which flows through the diluent tube 12. Qₚᵣ is the flow through the precursor evaporator 2, and Q_{dil} is the flow that bypasses the precursor evaporator 2 and joins the previously-formed mixture of carrier gas and vapor downstream to dilute it, either of which flows may be measured in cm³/min or in L/min. In the embodiment shown in FIG. 1, the flow of Qₚᵣ may, for example, be in the range of about 1 to about 30, or alternatively about 1 to about 10, or alternatively about 1 to about 5, cm³/min.

As Qₚᵣ gas flows through inflow tube 8 into the evaporator 2, it entrains precursor material vapor from the vapor space 6 above the liquid surface. Although it is shown in FIG. 1 that inflow tube 8 feeds the carrier gas into the vapor space 6, the tube could also be extended below the surface of the liquid and bubbled up into the vapor space. The amount of vapor removed from the evaporator is passively controlled by the flow rate of the Qₚᵣ carrier gas and the temperature of the precursor material (Tₚᵣ), as controlled by the temperature of the bath 4. The precursor material does not necessarily need to be in liquid-vapor equilibrium within the evaporator. However, the system is preferably at steady-state conditions to deliver a constant supply of precursor vapor, and, thus, to ultimately produce a stable source of aerosol particles. In a preferred embodiment, only 2-way valves and no 3-way valves are used in the piping.

The Qₚᵣ and Q_{dil} flows combine downstream from the evaporator 2 in the outflow tube 10, and mix before entering a 6 mm OD/4 mm ID quartz tube reactor and furnace 14 with temperature (T_{furn}). In the furnace 14, the vapor is thermally decomposed to form aerosolized particles of the precursor material. T_{furn} may, for example, be in the range of about 750 to about 850° C.

With a total gas flow rate of the Qₚᵣ flow and the Q_{dil} flow kept substantially constant at about 1.5 LPM, the total residence time within this particle generator may be suitably maintained at about 150 ms. In the hot zone of the tube furnace 14, the vapor of the precursor material undergoes thermal decomposition in the presence of the carrier gas, and the onset of homogeneous nucleation occurs at temperatures as low as 750° C. to form solid particles. Neat carrier gas that is used as a diluent, and thus flows in unmixed with vapor through diluent tube 12, forms a diluted mixture of vapor and carrier gas, and the diluted mixture is passed to the furnace 14 in the same manner as described above, and the vapor in this event is thermally decomposed in the presence of the total volume of carrier gas.

Upon exiting the furnace 14, the aerosol of solid particles cools, and enters an aerosol charger (such as an aerosol charger 16) in which the aerosol particles are charged with gas ions produced typically by exposure of the flowing stream to beta particles. The charger provides the aerosol with a known charge distribution, from which the size distribution of the as-generated aerosol may be determined. An aerosol charger as used herein functions as what is referred to in the art as an aerosol neutralizer or a diffusion charger. The aerosol charger functions to place a selected charge distribution on a population of aerosol particles. used to perform this function by subjecting the aerosol to ionizing radiation. The radioactive source ionizes the surrounding atmosphere into positive and negative ions. Particles carrying a high charge discharge by capturing ions of opposite polarity, and the particles reach change equilibrium such that the aerosol carries a bipolar distribution. Means for placing a selected charge on a population of aerosol particles include an aerosol charger as described above, and a suitable instrument to use for this purpose includes an ⁸⁵Kr aerosol charger (Model No. 4077) from TSI Incorporated (“TSI”), 500 Cardigan Road, Shoreview, Minn. 55126-3996 U.S.A.

To describe the size of the aerosol particles produced by the method and apparatus hereof, the mobility diameter of the particles may be determined by use of a differential mobility analyzer (“DMA”). Referring again to FIG. 1, the aerosol of particles flows from the aerosol charger 16 to a DMA classification instrument. In the operation of a DMA, an aerosol is introduced as an annular flow between two coaxial cylinders. A potential is applied to a center rod of the DMA, and the applied voltage corresponds to a specific preselected mobility diameter. Oppositely charged particles follow the electric field lines created within the DMA and migrate toward the center rod of the DMA. As these particles are transported across a particle-free laminar sheath flow by the electric field, they are simultaneously carried downstream through the DMA by the sheath flow. If particles carry only one elementary charge, their mobility is only dependent upon the particle mobility diameter. Further, if these particles are spherical, their mobility diameter is equivalent to the physical diameter of the particles. Thus, particles with different mobility diameters follow different trajectories within the DMA. The particles having a ratio between the electrostatic (charge based) and drag (diameter based) forces acting upon them that corresponds to the preselected mobility diameter are removed from the DMA through an exit slit at the bottom of the charged rod as a monodisperse aerosol flow with variations reduced to about 10% on diameter.

In the apparatus of this invention, the DMA used for size classification can be either a long DMA 18 or a nano DMA 20. With both DMAs operating with a ratio of sheath flow to aerosol flow of about 10 to 1, and with a sheath flow of about 15 LPM, the long DMA is in general suitable for use to classify aerosol particles having a mobility diameter of 20 nm<dₘ<250 nm, and the nano-DMA is in general suitable for use to classify aerosol particles having 3 nm<dₘ<60 nm. A DMA suitable for use as a long DMA includes a TSI Model 3081 DMA, and a DMA suitable for use as a nano DMA includes a TSI Model No. 3085 DMA. DMAs suitable for use herein, and the operation thereof, are also described in U.S. Pat. Nos. 5,596,136; 6,230,572; and 6,544,484, each of which is incorporated in its entirety as a part hereof for all purposes.

The aerosol particles, having been size classified in one of the DMAs, are then detected with either a condensation nucleus counter (CNC) for low concentration aerosols (having a concentration of less than about 10⁵ particles/cm³), or an aerosol electrometer (AE) for high concentration aerosols (having a concentration between about 10³ and about 10⁹ particles/cm³). The CNC uses a condensation technique to enlarge submicrometer particles to a size that can be easily detected optically, typically using water or alcohol (such as n-butanol) as the condensing fluid, and a suitable instrument to use for this purpose is a Model No. 3025A Condensation Nucleus Counter from TSI. In the AE, current carried by charged aerosol particles is detected with an electrometer with femtoampere sensitivity, and a suitable instrument to use for this purpose is a Model No. 3068A Aerosol Electrometer from TSI.

Particle size distributions of the as-generated aerosols are measured by scanning across a voltage range consisting of a series of discrete voltage steps applied to the DMA, and detecting the total particle concentration of particles corresponding to each voltage step, each of which steps corresponds to a preselected mobility diameter, or size bin. A potential is applied to the DMA, and the system is allowed to equilibrate for an equilibration time (e.g. 10 sec) that is sufficiently long to insure that the particles classified from the previous size bins are removed from the interior volume of the DMA. Thus, this time must be longer than the residence time of the system between the DMA and detector to insure that the particles classified within a specific voltage range have time to reach the detector and do not merge with particles classified during the previous voltage set point. Following equilibration, the total number of particles detected by the AE or the CNC during the specific voltage step for a preselected counting time is then recorded as an average particle concentration. The measured particle concentration is then inverted into the as-synthesized aerosol particle number distribution dN/d log (dₘ) by following the method originally developed by Knutson [“Extended Electric Mobility Method for Measuring Aerosol Particle Size and Concentration” in Fine Particles: Aerosol Generation, Measurement and Sampling, Liu, ed., Academic Press, New York, pages 740˜762 (1976)] and Hoppel [“Determination of the Aerosol Size Distribution from the Mobility Distribution of the Charged Fraction of Aerosols”, J. Aerosol Sci., 9:41˜54 (1978)], and refined by Hagen and Alofs [“Linear Inversion Method to Obtain Aerosol Size Distributions from Measurements with a Differential Mobility Analyzer”, Aerosol Sci. Technology, 2:465˜475 (1983)]. This inversion calculation accounts for instrument factors, including charging efficiency, detector efficiency, and DMA transmission efficiency as a function of particle size. Using a similar technique, a steady production of a classified aerosol can be provided by maintaining a constant voltage on the DMA that corresponds to a preselected mobility diameter.

What is claimed is:

1. A method of producing aerosol particles from a precursor material, comprising (a) providing a vapor of the precursor material, and (b) thermally decomposing the vapor.

2. A method according to claim 1 which further comprises a step of contacting the vapor with a carrier gas to form an initial mixture thereof, and wherein the vapor is thermally decomposed in the presence of the carrier gas.

3. A method according to claim 2 further comprising a step of regulating the rate of flow of carrier gas.

4. A method according to claim 2 which further comprises a step of contacting the initial mixture of vapor and carrier gas with additional, diluent carrier gas (which is unmixed with vapor) to form a diluted mixture of vapor and carrier gas.

5. A method according to claim 4 wherein the rate of flow of carrier gas to form the initial mixture of vapor and carrier gas, and the rate of flow of diluent carrier gas, are regulated separately or together.

6. A method according to claim 1 wherein the precursor material is vaporized from a liquid.

7. A method according to claim 6 wherein the liquid is heated or cooled.

8. A method according to claim 1 further comprising a step of regulating the temperature at which thermal decomposition of the vapor occurs.

9. A method according to claim 1 wherein the step of thermally decomposing the vapor comprises a step of feeding the vapor to a furnace.

10. A method according to claim 2 wherein the step of thermally decomposing the vapor comprises a step of feeding the mixture of carrier gas and vapor to a furnace.

11. An apparatus for producing aerosol particles from a precursor material, comprising (a) an evaporator to form a vapor of the precursor material, and (b) means to thermally decompose the vapor.

12. An apparatus according to claim 11 wherein the evaporator heats or cools the precursor material.

13. An apparatus according to claim 11 wherein the evaporator further comprises means to form a mixture of the vapor and a carrier gas, and wherein the means to thermally decompose the vapor thermally decomposes the vapor in the presence of the carrier gas.

14. An apparatus according to claim 11 wherein the evaporator comprises an enclosed container in which liquid precursor material is heated or cooled to provide vaporized precursor material in a vapor space of the container above the surface of the liquid.

15. An apparatus according to claim 14 further comprising an inflow tube through which carrier gas is fed into the container, and an outflow tube to discharge a mixture of vapor and carrier gas.

16. An apparatus according to claim 14 wherein carrier gas is fed into the vapor space.

17. An apparatus according to claim 14 wherein carrier gas is fed into the liquid beneath its surface.

18. An apparatus according to claim 15 further comprising a diluent tube through which carrier gas that is unmixed with vapor is fed into the mixture of vapor and carrier gas.

19. An apparatus according to claim 18 further comprising a valve to regulate the flow of carrier gas in the inflow tube, and a valve to regulate the flow of carrier gas in the diluent tube.

20. An apparatus according to claim 11 wherein the means to thermally decompose the vapor comprises a furnace.
